(19) United States
(12) Patent Application Publication
(10) Pub. No.: US 2004/0249918 A1
(43) Pub. Date: Dec. 9, 2004

(54) Facilitating replication of a service processor configuration

(75) Inventor: Roger N. Sunshine, Austin, TX (US)

Correspondence Address: Raymond M. Galasso, Simon, Galasso & Frantz PLC, P.O. Box 26503, Austin, TX, 78755-0503, US

(73) Assignee: Newisys, Inc.

(21) Appl. No.: 10/455,053

(22) Filed: Jun. 5, 2003

(51) Int. Cl. G06F 15/173

(52) U.S. Cl. 709/223

(57) ABSTRACT

One embodiment of the disclosures made herein is a method for facilitating replication of a service processor configuration. In accordance with such an embodiment, an operation is performed for requesting configuration data required for facilitating replication of at least a portion of a baseline service processor configuration onto a first service processor. The operation of requesting is performed by the first service processor and a configuration dataset maintained on the first service processor represents a service processor configuration of the first service processor. After requesting the required configuration data, an operation is performed for accessing the required configuration data within a configuration dataset maintained on a second service processor. The configuration dataset maintained on the second service processor represents the baseline service processor configuration. An operation for processing at least a portion of the required configuration data may be performed after accessing the required configuration data. Examples of processing the required configuration data include altering, deleting, coalescing, verifying and/or acknowledging at least of portion of the required configuration data. After accessing the required configuration data and processing any required portion of the required configuration data, an operation is performed for updating the configuration dataset maintained on the first service processor to include at least a portion of the required configuration data.

### FIELD OF THE DISCLOSURE

The disclosures made herein relate generally to data processing systems and more particularly to facilitating replication of a service processor configuration.

### BACKGROUND

In a distributed data processing environment, multiple service processors act together to support a connected data processing apparatus. The connected data processing apparatus comprises one or more data processing systems. Each one of the service processors is typically adapted for configuring and monitoring a respective one of the data processing systems. While there may be several service processors within any particular environment, it is common for all of the service processors within a particular environment to be configured virtually identically.

Conventional approaches for facilitating configuration of an unconfigured service processor of a data processing system include manually entering the service processor network configuration on an operator panel of the data processing system, then launching a web browser and connecting to the HTTPS server on the unconfigured service processor. After implementing connection to the HTTPS server, an initial user account is created via a web form, and once completed, all management capabilities are capable of being configured from the web browser. While this approach accomplishes the objective of configuring the service processor, it is limited because it rapidly becomes tedious, repetitive, unproductive and prone to error when configuring service processor of dozens or hundreds of data processing systems.

Furthermore, conventional approaches for configuring data processing systems exhibit one or more limitations as applied to facilitating configuration of a service processor of a data processing system. Hard drive image servers, web-based update servers, host-based update servers and information redistribution programs are examples of such conventional approaches. Hard drive image servers (e.g., Symantec brand Ghost software and similar commercially-available software products) are useful for facilitating configuration of a new data processing system (e.g., a personal computer) from a central distribution server. But, hard drive image servers generally have the disadvantage of not being well suited for the limited environment associated with a service processor. Additionally, hard drive image servers are intended for complete replacement of the software on a data processing system rather than a small selection of configuration files and generally do not use an encrypted channel to transmit required configuration information. Known web-based or host-based update servers (e.g., Microsoft® Windows® Update software) generally update programs, libraries and other binary objects, rather than the configuration data for a system, which limits their applicability for configuring SP's. Information redistribution programs (e.g., a UNIX-based RDIST program) are often used to push data (rather than pull) from a central server to multiple clients. But, these information redistribution programs perform their functionality via an unsecured channel and require manual intervention in the creation and maintenance of their own configuration files.

Therefore, methods and equipment adapted for facilitating configuration of service processors in a manner that overcomes limitations associated with conventional approaches for facilitating configuration of service processors would be useful.

### BRIEF DESCRIPTION OF THE DRAWINGS

FIG. 1 depicts a method for facilitating replication of baseline service processor configuration data in accordance with an embodiment of the disclosures made herein.

FIG. 2 depicts a network of data processing systems, wherein the data processing systems are configured for facilitating replication of baseline service processor configuration data in accordance with an embodiment of the disclosures made herein.

FIG. 3 depicts an embodiment of the inquiring data processing system depicted in FIG. 2, wherein the inquiring data processing system is adapted for enabling configuration replication functionality to be invoked via a system management interface arrangement.

FIG. 4 depicts an embodiment of the inquiring data processing system depicted in FIG. 2, wherein the inquiring data processing system is adapted for enabling configuration replication functionality to be invoked via a remote network access arrangement.

### DETAILED DESCRIPTION OF THE DRAWINGS

The disclosures made herein relate to facilitating replication of baseline service processor configuration data of a data processing system (i.e., a baseline data processing system) onto another data processing system (i.e., an inquiring data processing system). Methods and equipment in accordance with embodiments of the disclosures made herein are configured for facilitating such replication in a system-automated manner requiring little or no human intervention (i.e., automated configuration replication functionality). Replicated baseline service processor configuration data may represent all or a portion of a baseline service processor configuration. An example of a baseline service processor configuration is a service processor configuration of a data processing system that is operating properly within a particular environment.

A service processor is typically implemented in a data processing system, which comprises the service processor and a data processing module for providing platform functionality. For example, one embodiment of a data processing system as disclosed herein is a server that includes components for providing server functionality (i.e., a platform) and components for providing service processor functionality (i.e., the service processor). The service processor provides functionality such as remote management, diagnostics, and/or monitoring support of the platform portion of the data processing system. To provide such functionality, configuration of a considerable amount of information is required to permit proper operation of the service processor. In view of such required information, the process of facilitating configuration of the service processor on multiple data processing systems using conventional techniques for configuring a service processor is known to be tedious, repetitive, unproductive and prone to error.

In an environment where a plurality of data processing systems are providing networked and/or distributed data processing functionality, it is common for the service processors of such data processing systems to be configured virtually identically to each other. Facilitating replication of baseline service processor configuration data using methods and equipment in accordance with embodiments of the disclosures made herein is capable of greatly simplifying the process of installing one or more additional data processing systems at a particular location and configuring the SP of such one or more additional data processing systems. Accordingly, replicating such baseline service processor configuration data using methods and equipment as disclosed herein is facilitated in a manner that is less tedious, less repetitive, more productive and less prone to error than conventional techniques for configuring a service processor.

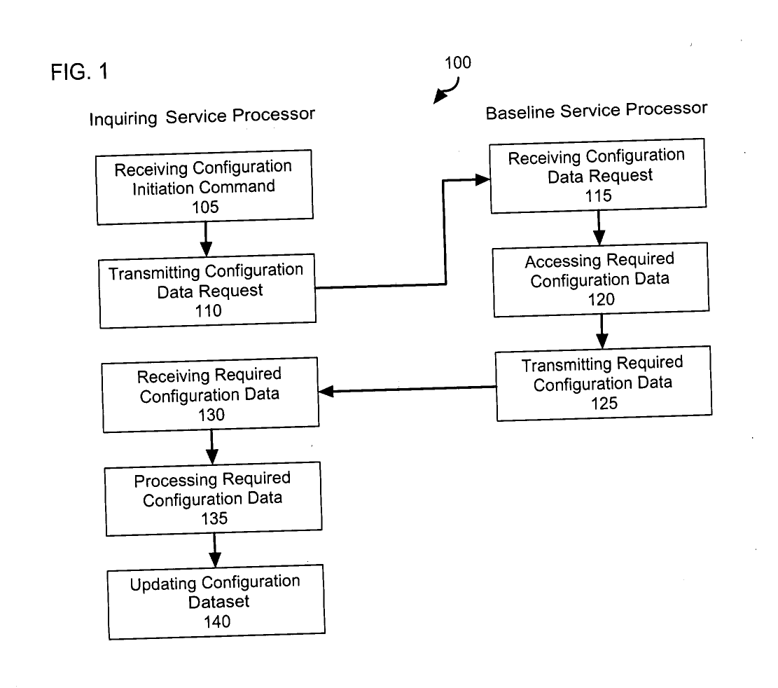

Turning now to discussion of specific drawings, a method 100 in accordance with an embodiment of the disclosures made herein is depicted in FIG. 1. The method 100 is configured for facilitating replication of baseline service processor configuration data maintained on a baseline data processing system onto an inquiring data processing system in a system-automated manner. In this manner, a service processor of the inquiring data processing system can be configured with little to no human intervention.

Processes, operations and/or steps of the method 100, as well as other methods in accordance with embodiments of the disclosures made herein, are implemented by at least one of a configuration application and a Common Gateway Interface (CGI) application. The CGI application facilitates serving service processor configuration data from a baseline data processing system to an inquiring data processing system. The configuration application facilitates retrieving service processor configuration data from the baseline data processing system and applying it locally on the inquiring data processing system. The baseline data processing system comprises a configuration dataset representing a respective service processor configuration (i.e., a baseline service processor configuration). The inquiring data processing system comprises a configuration dataset representing a respective service processor configuration (i.e., a service processor configuration requiring completion or update).

A replication control structure (e.g., a table) including information for facilitating replication of baseline service processor configuration data is utilized by at least some methods and equipment in accordance with embodiments of the disclosures made herein (e.g., the method 100). Examples of such information include, but are not limited to, configuration data identity information, configuration dataset storage information and configuration data processing information.

A data structure specifying CONFIG entity implementations adapted for facilitating configuration replication functionality as disclosed herein is an embodiment of a replication control structure. In such an embodiment, a Target field of a Config entity specifies the identity of a particular entity of a service processor configuration. The Target field is used by a client application (e.g., a configuration application running on an inquiring data processing system) and the server application (e.g., a CGI application running on the baseline data processing system) to determine which particular entity of a service processor configuration is being operated on (e.g., accessed and processed). The client application iterates over a list of Config entities and sends a request to the server application for each indicated target. A FILENAME field of a Config entity specifies a local file for both the client and server applications. For example, a source file is specified on the server application and a destination file is specified on the client application. A FETCHER field of a Config entity specifies a processing functionality to implement in order to process required configuration data in a source file or destination file. Examples of the processing functionality include removing invalid entries in files, coalescing information from multiple files, verifying file contents, etc. Through processing required configuration data, the potential for adverse situations such as security breaches and overall replication functionality problems can be reduced.

As mentioned above, processes, operations and/or steps of the method 100 are implemented by at least one of a configuration application and a Common Gateway Interface (CGI) application in conjunction with a replication control structure. It is contemplated herein that both the inquiring data processing system and the baseline data processing system include essentially identical copies of the configuration application and the CGI application. Such an arrangement is desirable and advantageous in that it permnits each data processing system to facilitate inquiring data processing system replication functionality (i.e. replication functionality facilitated by an inquiring data processing system) and baseline data processing system replication functionality (i.e. replication functionality facilitated by a baseline data processing system). Depending on circumstances, a particular data processing system may be an inquiring data processing system within a network of data processing systems at one point in time (e.g., upon initial start-up of the particular data processing system) and may be a baseline data processing system within the network of data processing systems at another point in time (e.g., upon initial start-up of a newly added data processing system).

In at least one embodiment of the disclosures made herein, the configuration application, the CGI application and replication control structure represent respective application components of a data processing program (e.g., a Configuration Replication Data Processing Program). The CGI application represents a first application component adapted for facilitating serving of configuration data. The configuration application represents a second application component adapted for facilitating retrieval of the required configuration data and applying the required configuration data on a local data processing system. The replication control structure represents a third application component that includes information utilized by both the CGI application and the configuration application for facilitating replication of baseline service processor configuration data. Accordingly, in at least one embodiment of the disclosures made herein, both the inquiring data processing system and the baseline data processing system include essentially identical copies of the Configuration Replication Data Processing Program.

Still referring to FIG. 1, an operation 105 is performed by the configuration application of the inquiring service processor for receiving a configuration initiation command. The configuration initiation command invokes system-automated configuration of the inquiring service processor. One embodiment of the configuration initiation command includes human intervention being required for providing a minimal degree of pre-configuration information (e.g., providing one or more required network addresses) and issuing the configuration initiation command. For example, input may be manually entered via an operator panel interface of the inquiring service processor. As discussed in greater detail below, other examples of invoking system-automated configuration of the inquiring service processor include invoking system-automated configuration via a web console or via a shell command. Another embodiment of the configuration initiation command includes preparation and issuing of the configuration initiation command (including specification of any pre-configuration information) being performed in an automated manner without any human intervention.

In response to receiving the configuration initiation command, an operation 110 is performed by the inquiring service processor for transmitting a configuration data request from the inquiring service processor for reception by the baseline service processor. It is contemplated herein that operations of transmitting may include establishing secure channels (e.g., via Secure HTTP protocol) for facilitating transmission of information. The configuration data request designates configuration data required for facilitating replication of at least a portion of the baseline service processor configuration onto the inquiring service processor (i.e., required configuration data). Transmitting the configuration data request is an example of requesting required configuration data. It is contemplated that requesting required configuration data may include accessing a replication control structure for identifying, for example, the required configuration data and/or configuration data source file information.

The baseline service processor performs an operation 115 for receiving the configuration data request, followed by an operation 120 for accessing the required configuration data. It is contemplated that accessing the required configuration data may include accessing a replication control structure for identifying, for example, configuration data source file information. In response to accessing the required configuration data, an operation 125 is performed by the baseline service processor for transmitting the required configuration data from the baseline service processor for reception by the inquiring service processor. It is contemplated that transmitting the required configuration data may include accessing a replication control structure for identifying, for example, configuration data destination file information.

In response to the inquiring service processor performing an operation 130 for receiving the required configuration data, the inquiring service processor performs an operation 135 for processing all or a portion of the required configuration data. Examples of processing the required configuration data include, but are not limited to, altering, deleting, coalescing, verifying and acknowledging at least a of portion of the required configuration data. It is contemplated that processing all of a portion of the required configuration data may include accessing a replication control structure for identifying, for example, configuration data processing information.

After receiving the required configuration data and performing any required processing, the inquiring service processor performs an operation 140 for updating the configuration dataset representing the service processor configuration of the inquiring service processor to include at least a portion of the required configuration data. It is contemplated that updating the configuration dataset may include accessing a replication control structure for identifying, for example, configuration data destination file information and storing at least a portion of the required configuration data in accordance with the configuration data destination file information (e.g., a storage location corresponding to configuration dataset storage information designated in a replication control structure).

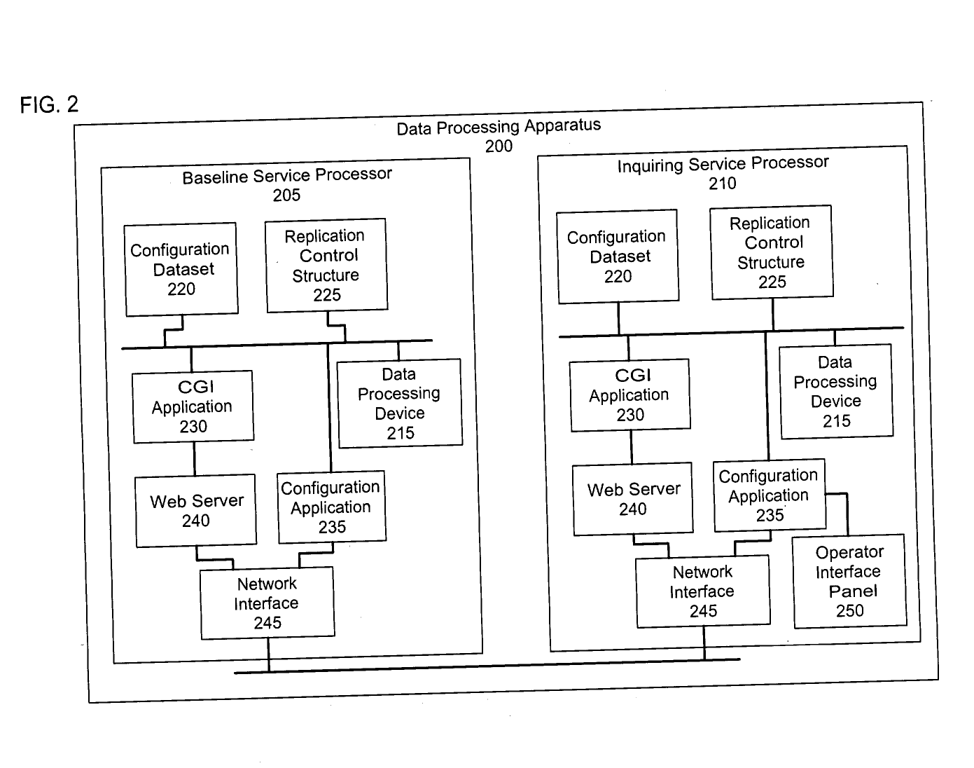

FIG. 2 depicts a data processing apparatus 200 in accordance with an embodiment of the disclosures made herein. The apparatus 200 includes a baseline data processing system 205 (i.e., a first data processing system) and an inquiring data processing system 210 (i.e., a second data processing system). The baseline data processing system 205 and the inquiring data processing system 210 are connected in a manner enabling communication therebetween. The baseline data processing system 205 and the inquiring data processing system 210 are each adapted for enabling automated configuration replication functionality as disclosed herein to be facilitated. The method 100 discussed above is an embodiment of such automated configuration replication functionality. A server is an example of a data processing system comprising each service processor of the network 200. It is contemplated that the network 200 may include one or more other baseline service processors and/or inquiring service processors.

The baseline service processor 205 and the inquiring service processor 210 each include a data processing device 215, a configuration dataset 220, a replication control structure 225, a CGI application 230, a configuration application 235, a web server 240, a network interface 245 and an operator interface panel 250. The configuration dataset 220 represents a service processor configuration of the service processor. The data processing device 215, the configuration dataset 220, the replication control structure 225, the CGI application 230 and the configuration application 235 are connected in a manner for enabling interaction (e.g., communication) therebetween. The web server 240 facilitates interaction between the CGI application 230 and the network interface 245. Although not specifically depicted, means for retaining the configuration dataset (e.g., memory, disk drive, etc) is provided and is accessible by the data processing device 215.

It will be understood by a skilled person that the data processing device 215, the configuration dataset 220, the replication control structure 225, the CGI application 230, the configuration application 235, the web server 240 and the network interface 245 are depicted herein as being functional modules which may each comprise a combination of hardware, software, embedded instructions, data and the like. Furthermore, such functional modules may share all or a portion of such hardware, software, embedded instructions, data and the like. It will also be understood that the interconnection between such functional modules is depicted in a manner for supporting interaction in accordance with embodiments of the disclosures made herein and, therefore, does not depict the only implementation of interconnection. For example, one functional module may include hardware that is connected to hardware of another module in a manner different than or in addition to the configuration depicted.

The replication control structure 225, the CGI application 230 and the configuration application 235 are adapted for facilitating respective portions of automated configuration replication functionality as disclosed herein. Inclusion of the replication control structure 225, the CGI application 230 and the configuration application 235 on both the baseline service processor 205 and the inquiring service processor 210 results in the baseline service processor 205 and the inquiring service processor 210 both being adapted for carrying out all portions of automated configuration replication functionality disclosed herein (i.e., being an inquiring service processor and/or a baseline service processor). As mentioned above in reference to FIG. 1, such an arrangement is desirable and advantageous in that it permits each service processor to facilitate inquiring service processor functionality and baseline service processor functionality.

The operator interface panel 250 of the inquiring service processor 210 enables automated configuration replication functionality as disclosed herein to be manually invoked. Such manual invoking may include manually entering pre-configuration information (e.g., an IP address), which is required for enabling replication of the service processor configuration of the baseline service processor 205 onto the inquiring service processor 210. Furthermore, when the inquiring service processor 210 is a newly installed service processor (i.e., having a service processor that is not yet configured for operation), the operator interface panel represents a convenient means, and potentially only means, for enabling the configuration replication functionality to be invoked.

After the inquiring service processor 210 is initially configured, there often exists the need to re-configure (i.e. update) the existing service processor configuration. To this end, it is contemplated that a shell command or a web console may be used for invoking configuration replication functionality rather than the operator interface panel 250.

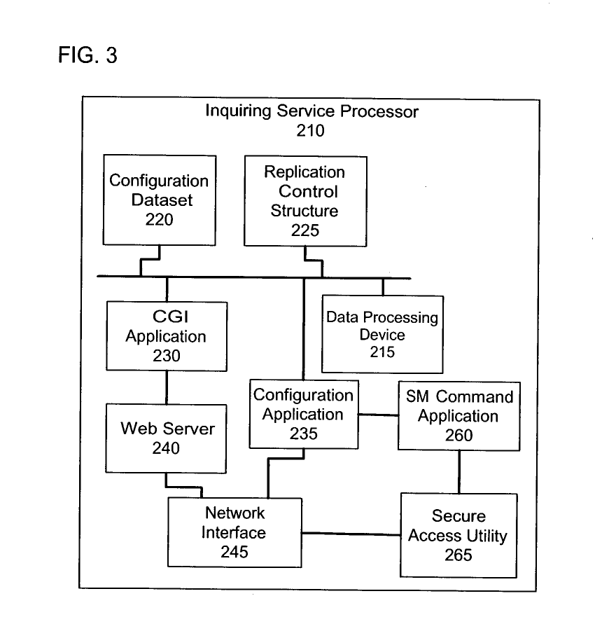

FIG. 3 depicts an embodiment of the inquiring service processor 210 including a system management command application 260 and a secure access utility 265 (e.g., secure shell utility). The system management command application 260 and the secure access utility 265 are connected between the configuration application 235 and the network interface 245 for enabling an operator to invoke configuration replication functionality via a desktop interface of the inquiring service processor 210.

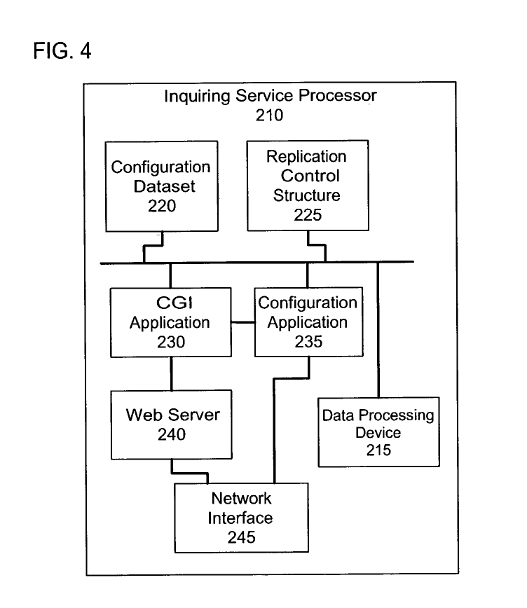

FIG. 4 depicts an embodiment of the inquiring service processor 210 wherein the CGI application 230 is coupled to the configuration application 235 and is adapted for invoking configuration replication functionality through the configuration application. Accordingly, through communication enabled by the web server 240 and network interface 245, an operator may utilize a remote network access means for invoking configuration replication functionality. An Internet website accessed using a remote data processing system (not shown) is an example of such a remote network access means.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical, chemical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method for facilitating replication of a service processor configuration, comprising:
requesting configuration data required for facilitating replication of at least a portion of a baseline service processor configuration onto a first service processor, wherein said requesting is performed by the first service processor and wherein a configuration dataset maintained on the first service processor represents a service processor configuration of the first service processor; and
accessing said required configuration data within a configuration dataset maintained on a second service processor after performing said requesting, wherein the configuration dataset maintained on the second data processing represents the baseline service processor configuration.

2. The method of claim 1 wherein:
said requesting includes transmitting a configuration data request from the first service processor for reception by the second service processor; and
said configuration data request designates said required configuration data.

3. The method of claim 1 wherein:
requesting said required configuration data includes accessing a replication control structure maintained on the first service processor for identifying said required configuration data; and
accessing said required configuration data includes accessing a replication control structure maintained on the second service processor for identifying configuration data source file information.

4. The method of claim 3 wherein each one of said replication control structures includes at least one of configuration data identity information, configuration dataset storage information and configuration data processing information.

5. The method of claim 1, further comprising:
processing said required configuration data after performing said accessing, wherein said processing includes at least one of altering, deleting, coalescing, verifying and acknowledging at least of portion of said required configuration data.

6. The method of claim 5, further comprising:
updating the configuration dataset maintained on the first service processor to include at least a portion of said required configuration data after performing said processing.

7. The method of claim 6 wherein said updating includes storing at least a portion of said required configuration data at a storage location corresponding to configuration dataset storage information designated in the replication control structure maintained on at least one of first and the second service processors.

8. The method of claim 7, further comprising:
transmitting said required configuration data from the second service processor for reception by the first service processor prior to said updating.

9. The method of claim 1 wherein:
said requesting is performed by a first Configuration Replication Data Processing Program (CRDPP) maintained on the first service processor;
said accessing is performed by a second Configuration Replication Data Processing Program (CRDPP) maintained on the second service processor; and
the first CRDPP is essentially identical to the second CRDPP.

10. The method of claim 9, further comprising:
transmitting said required configuration data from the second service processor for reception by the first service processor in response to accessing said required configuration data, wherein said transmitting is performed by the second CRDPP.

11. The method of claim 10 wherein:
the first CRDPP and the second CRDPP include essentially identical replication control structures;
said requesting includes accessing said replication control structure of the first CRDPP for identifying configuration data source file information;
said updating includes storing at least a portion of said required configuration data at a storage location corresponding to configuration dataset storage information designated in the replication control structure; and
said transmitting includes accessing said replication control structure of the second CRDPP for identifying configuration data destination file information.

12. The method of claim 1 wherein said requesting includes establishing a secure channel over which a configuration data request designating said required configuration data is transmitted.

13. A method for facilitating replication of a service processor configuration, comprising:
transmitting a configuration data request designating configuration data required for facilitating replication of at least a portion of a baseline service processor configuration onto a first service processor, wherein the configuration data request is transmitted from the first service processor for reception by a second service processor and wherein a configuration dataset maintained on the first service processor represents a service processor configuration of the first service processor; and
receiving said required configuration data by the first service processor in response to said required configuration data being accessed within a configuration dataset maintained on the second service processor and being transmitted from the second service processor for reception by the first service processor, wherein the configuration dataset maintained on the second data processing represents the baseline service processor configuration.

14. The method of claim 13, further comprising:
accessing a replication control structure for identifying said required configuration data prior to performing said transmitting, wherein the replication control structure includes at least one of configuration data identity information, configuration dataset storage information and configuration data processing information.

15. The method of claim 13, further comprising:
processing said required configuration data after performing said receiving, wherein said processing includes at least one of altering, deleting, coalescing, verifying and acknowledging at least of portion of said required configuration data.

16. The method of claim 13 further comprising:
accessing a replication control structure of a Configuration Replication Data Processing Program (CRDPP) maintained on the first service processor for identifying said required configuration data prior to said transmitting, wherein the replication control structure includes at least one of configuration data identity information, configuration dataset storage information and configuration data processing information.

17. The method of claim 13, further comprising:
updating the configuration dataset maintained on the first service processor to include at least a portion of said required configuration data after receiving said required configuration data.

18. The method of claim 17 wherein said updating includes storing at least a portion of said required configuration data at a storage location corresponding to configuration dataset storage information designated in the replication control structure maintained on at least one of first and the second service processors.

19. A method for facilitating replication of a service processor configuration, comprising:
receiving a configuration data request designating configuration data required for facilitating replication of at least a portion of a baseline service processor configuration onto a first service processor, wherein the configuration data request is transmitted from the first service processor for reception by a second service processor and wherein a configuration dataset maintained on the first service processor represents the service processor configuration of the first service processor; and
accessing said required configuration data within a configuration dataset of the second service processor after performing said receiving, wherein the configuration dataset maintained on the second data processing represents the baseline service processor configuration.

20. The method of claim 19 wherein accessing said required configuration data includes accessing a replication control structure maintained on the second service processor for identifying configuration data source file information.

21. The method of claim 19, further comprising:
transmitting said required configuration data from the second service processor for reception by the first service processor after accessing said required configuration data.

22. The method of claim 21, further comprising:
processing said required configuration data after said required configuration data is received by the first service processor, wherein said processing includes at least one of altering, deleting, coalescing, verifying and acknowledging at least of portion of said required configuration data.

23. The method of claim 22 wherein:
said processing is performed by a first Configuration Replication Data Processing Program (CRDPP) maintained on the first service processor;
said accessing is performed by a second Configuration Replication Data Processing Program (CRDPP) maintained on the second service processor; and
the first CRDPP is essentially identical to the second CRDPP.

24. The method of claim 23 wherein:
the first CRDPP and the second CRDPP include essentially identical replication control structures;
said accessing includes accessing said replication control structure of the second CRDPP for identifying configuration data source file information; and
said processing includes accessing said replication control structure of the first CRDPP for identifying configuration data processing information.

25. The method of claim 19, further comprising:
updating the configuration dataset maintained on the first service processor to include at least a portion of said required configuration data after performing said processing.

26. The method of claim 25 wherein said updating includes storing at least a portion of said required configuration data at a storage location corresponding to configuration dataset storage information designated in the replication control structure maintained on at least one of first and the second service processors.

27. The method of claim 26, further comprising:
processing said required configuration data prior to said updating, wherein said processing includes at least one of altering, deleting, coalescing, verifying and acknowledging at least of portion of said required configuration data.

28. A service processor, comprising:
a data processing device;
a configuration dataset representing a service processor configuration of the service processor;
means for retaining the configuration dataset;
a replication control structure including information capable of enabling automated configuration replication functionality; and
a data processor program accessible by the data processing device, wherein the data processing program is adapted for enabling the data processing device to facilitate:
transmitting a configuration data request designating configuration data required for facilitating replication of at least a portion of a baseline service processor configuration onto said means for retaining, wherein the configuration data request is transmitted from the service processor for reception by an other service processor; and
receiving said required configuration data in response to said required configuration data being accessed within a configuration dataset maintained on the other service processor and being transmitted from the other second service processor for reception by the service processor, wherein the configuration dataset maintained on the other data processing represents the baseline service processor configuration.

29. The system of claim 28 wherein:
the data processing program is further adapted for enabling the data processing device to facilitate accessing the replication control structure for identifying said required configuration data prior to performing said transmitting; and
the replication control structure includes at least one of configuration data identity information, configuration dataset storage information and configuration data processing information.

30. The system of claim 28 wherein the replication control structure includes at least one of configuration data identity information, configuration dataset storage information and configuration data processing information.

31. The system of claim 28 wherein:
the data processing program is further adapted for enabling the data processing device to facilitate processing said required configuration data after performing said receiving; and
said processing includes at least one of altering, deleting, coalescing, verifying and acknowledging at least of portion of said required configuration data.

32. The system of claim 28 wherein the data processing program is further adapted for enabling the data processing device to facilitate updating the configuration dataset of the data processing device to include at least a portion of said required configuration data.

33. The system of claim 32 wherein enabling the data processing device to facilitate said updating includes enabling the data processing device to facilitate storing at least a portion of said required configuration data at a storage location corresponding to configuration dataset storage information designated in the replication control structure.

34. A service processor, comprising:
a service processor;
a configuration dataset representing a service processor configuration of the service processor, wherein the configuration dataset represents a baseline service processor configuration for an other service processor;
a replication control structure including information capable of enabling automated configuration replication functionality; and
a data processor program accessible by the data processing device, wherein the data processing program is adapted for enabling the data processing device to facilitate:
receiving a configuration data request designating configuration data required for facilitating replication of at least a portion of the baseline service processor configuration onto the other service processor, wherein the configuration data request is transmitted from the other service processor for reception by the service processor; and
accessing said required configuration data within the configuration dataset of the service processor after performing said receiving.

35. The system of claim 34 wherein enabling the data processing device to facilitate accessing said required configuration data includes enabling the data processing device to facilitate accessing the replication control structure for identifying configuration data source file information.

36. The system of claim 34 wherein the data processing program is further adapted for enabling the data processing device to facilitate transmitting said required configuration data from the service processor for reception by the other service processor after accessing said required configuration data.

37. A service processor, comprising:
a data processing device;
a configuration dataset accessible by the data processing device and representing a service processor configuration of the service processor; and
means for facilitating automated configuration replication functionality.

38. The system of claim 37 wherein:
the configuration data set represents a baseline service processor configuration for another service processor; and
facilitating said automated configuration replication functionality includes replicating at least a portion of the baseline service processor configuration onto the other service processor.

39. The system of claim 37 wherein;
said means includes a replication control structure; and
facilitating said automated configuration replication functionality is at least partially dependent upon information maintained in the replication control structure.

40. The system of claim 37 wherein said means includes a data processor program configured for facilitating at least one of:
determining configuration data required for facilitating replication of at least a portion of a baseline service processor configuration, wherein said required configuration data is maintained within a configuration dataset representing the baseline service processor configuration;
requesting said required configuration data from a service processor on which the configuration dataset representing the baseline service processor configuration is maintained;
accessing said required configuration data within the configuration dataset representing the baseline service processor configuration; and
processing said required configuration data.

41. The system of claim 37 wherein:
said means includes a data processor program configured for facilitating:
determining configuration data required for facilitating replication of at least a portion of a baseline service processor configuration; and
processing said required configuration data;
said required configuration data is maintained within a configuration dataset representing the baseline service processor configuration; and
said processing includes at least one of altering, deleting, coalescing, verifying and acknowledging at least of portion of said required configuration data.

42. The system of claim 37 wherein:
said means includes a data processor program configured for facilitating:
requesting configuration data required for facilitating replication of at least a portion of a baseline service processor configuration; and
accessing said required configuration data within a configuration dataset representing the baseline service processor configuration;
requesting said required configuration data includes accessing a replication control structure maintained on the first service processor for identifying said required configuration data; and
accessing said required configuration data includes accessing a replication control structure is maintained on an other service processor for identifying configuration data source file information.

43. The system of claim 37 wherein said means includes:
a first application component adapted for facilitating serving of configuration data represents a baseline service processor configuration to another service processor; and
a second application component adapted for facilitating retrieval of said configuration data and applying said configuration data on the service processor.

44. The system of claim 43 wherein:
said means further includes a replication control structure including information required for facilitating said automated configuration replication functionality; and
portions of said facilitating serving and facilitating retrieval are at least partially dependent upon information maintained in the replication control structure.

45. The system of claim 44 wherein the replication control structure includes at least one of configuration data identity information, configuration dataset storage information and configuration data processing information.
